(19) United States
(12) Patent Application Publication
(10) Pub. No.: US 2009/0014252 A1
(43) Pub. Date: Jan. 15, 2009

(54) ELEVATOR DRIVE ASSEMBLY INCLUDING A CAPACITIVE ENERGY STORAGE DEVICE

(76) Inventors: Sastry V. Vedula, Glastonbury, CT (US); Mark S. Thompson, Tolland, CT (US)

Correspondence Address: CARLSON GASKEY & OLDS, 400 W MAPLE STE 350, BIRMINGHAM, MI, 48009, US

(21) Appl. No.: 12/159,798

(22) PCT Filed: Jan. 30, 2006
(86) PCT No.: PCT/US06/03075

§ 371 Date: Jul. 1, 2008

(51) Int. Cl. B66B 1/06

(52) U.S. Cl. 187/290

(57) ABSTRACT

An elevator drive assembly (20) includes a motor (28), drive (32) and a capacitive energy storage device (50). In a disclosed example, the capacitive energy storage device (50) comprises at least one nano-gate capacitor (52). The disclosed example has unique energy storage capabilities provided by the presence of the at least one nano-gate capacitor.

### FIELD OF THE INVENTION

This invention generally relates to elevators. More particularly, this invention relates to elevator drive assemblies including power consumption control.

### DESCRIPTION OF THE RELATED ART

Elevator systems include a drive assembly for providing the desired movement of the elevator car between landings within a building, for example. Most drive assemblies include an electric motor that generates the forces necessary to achieve the desired elevator car movement and a drive that controls power supply to the motor. In the case of a traction-based elevator, the electric motor provides rotation to a traction sheave that moves roping that is used to suspend an elevator car and counterweight, for example.

It is known to attempt to reduce peak power consumption by the electric motor and elevator drive assembly by providing an electrical energy storage. Proposed arrangements include batteries or traditional capacitors as an energy storage device. U.S. Pat. No. 6,742,630 shows an arrangement including so-called super-capacitors as part of an electrical energy storage arrangement. Previously proposed arrangements such as these have shortcomings. For example, batteries have the disadvantages associated with a relatively long time period for charging and discharging the battery, a relatively short life cycle and temperature dependence that affects the battery's performance. Super-capacitors have a high specific power and can be charged or discharged over shorter time periods compared to batteries. Super-capacitors, however, have a low specific energy when compared to a battery. Further, when discharging, the voltage associated with a super-capacitor drops over a larger range and on the order of 10-20%. Previous attempts to achieve a good mix of battery and super-capacitors for energy storage in an elevator system has not proven satisfactory.

Those skilled in the art are always striving to make improvements. It would be desirable to provide an energy storage arrangement for an elevator drive assembly that provides the advantages of batteries and super-capacitors, for example, without the associated drawbacks. This invention provides such a solution.

### SUMMARY OF THE INVENTION

An exemplary elevator drive assembly includes a motor and a drive that controls operation of the motor to achieve a desired elevator system operation. A capacitive energy storing device is electrically coupled with the drive or the motor for receiving electric energy from operation of the motor or providing electrical energy for use in operating the motor. The capacitive energy storing device includes at least one double-layer electrochemical capacitor.

In one example, the capacitive energy storing device comprises at least one nano-gate capacitor.

An exemplary method of operating an elevator drive assembly includes selectively electrically coupling a capacitive energy storing device that includes at least one double-layer electrochemical capacitor with a motor or a drive of the drive assembly. Electrical energy can be provided to the capacitive energy storing device when such energy results from operation of the motor during a first operating condition. Electrical energy from the capacitive energy storing device can be provided for operating the motor during a separate, second operating condition of the motor.

The various features and advantages of this invention will become apparent to those skilled in the art from the following detailed description of a currently preferred embodiment. The drawing that accompanies the detailed description can be briefly described as follows.

### BRIEF DESCRIPTION OF THE DRAWING

FIG. 1 schematically illustrates an example elevator drive assembly designed according to one embodiment of this invention.

### DETAILED DESCRIPTION

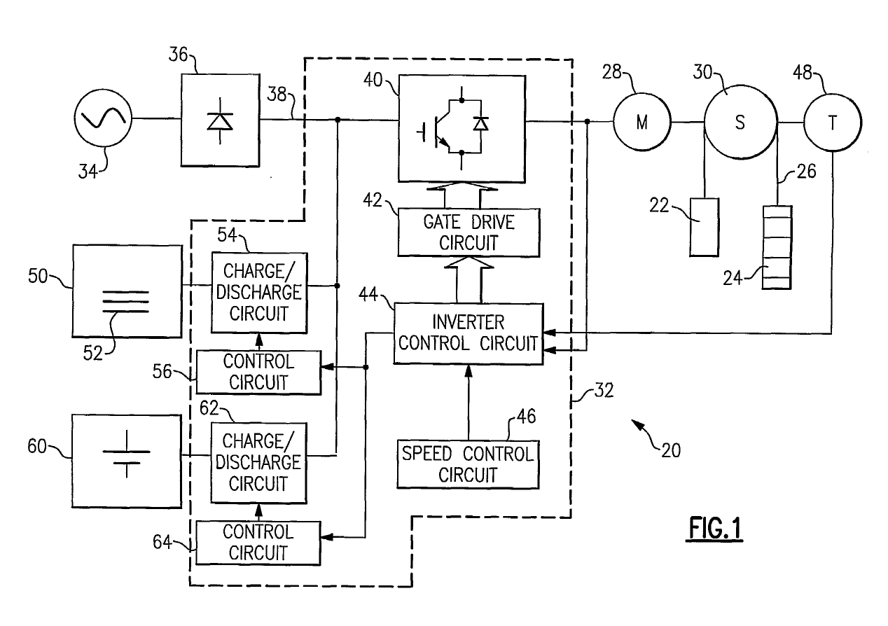

FIG. 1 schematically shows an elevator drive assembly 20 for providing desired movement of an elevator car 22. In the illustrated example, the elevator system is a traction-based system where the elevator car 22 is associated with a counterweight 24 through conventional roping 26. An electric motor 28 provides rotation to a traction sheave 30 to cause movement of the roping 26 and the car 22 and counterweight 24.

A drive 32 controls power supply to the motor 28 from a power source 34 such as a utility grid or a variable frequency ac source driven by a prime mover. In this example, the motor 28 is an AC induction motor and a rectifier 36 is provided between the power source 34 and the motor 28. One example includes a permanent magnet motor.

The drive 32 in this example includes a DC bus 38, at least one converter IGBT 40, an appropriate gate drive circuitry portion 42, an inverter control portion 44 and a speed control circuit 46. The just-mentioned portions of the drive 32 operate in a known manner. The inverter control portion 44 also receives feedback signals indicating what is provided to the motor 28 and signals from a speed sensor 48 that provides an indication of speed and other sensing information to derive torque, for example, provided to the traction sheave 30.

The illustrated example includes at least one capacitive energy storing device 50 that receives electrical energy based upon the motor 28 operating in a first condition such as a regenerative mode of operation. The capacitive energy storing device 50 stores such energy. At selected times, energy stored within the device 50 can be provided for operating the motor 28 during a second operating condition through a common DC bus, the converter IGBT 40 and charge a discharge control unit 54. In one example, when the motor 28 is decelerating or coasting, electrical energy is provided to charge the capacitive energy storing device 50 through a DC bus and the control unit 54. When the motor 28 is accelerating, energy is drawn from the capacitive energy storing device 50 and the control unit 54 to reduce power consumption from the power source 34, for example.

The example capacitive energy storing device 50 includes at least one double-layer electrochemical capacitor 52. Such a capacitor is different than conventional capacitors and different from the so-called super capacitors. In one example, the capacitor 52 is a nano-gate capacitor. Nano-gate capacitors have improved energy density compared to previous capacitors. Nano-gate capacitor energy density is higher than a nickel-Metalhydride (NI_MH) battery in some cases and almost equivalent to a large size lithium ion battery in some instances. At the same time, nano-gate capacitors have the unique advantage of a capacitor such as being able to charge and discharge in an extremely short time and operate over a large temperature range. Additionally, nano-gate capacitors have a very long lifetime in terms of cycle life. Therefore, nano-gate capacitors provide a unique capacitive energy storing device for use in an elevator drive assembly that has all of the advantages of a battery and a super-capacitor without any of their limitations.

The example drive 32 includes a control circuit 56 for operating the control unit 54 in tandem with the inverter control circuit 44 and the speed control circuit 46.

The illustrated example also includes a battery 60 that can be used for storing energy or providing energy to the motor 28, for example. In this example, the drive 32 includes a circuit 62 for regulating the charge or discharge of the battery 60 and a control circuit 64 for controlling the circuit 62 in tandem with the inverter control circuit 44 & speed control circuit 46.

The illustrated example provides enhanced energy efficiencies compared to other arrangements. The nano-gate capacitor provides better charging and energy storage capacity. The illustrated example also provides component cost and space savings, in part, because the nano-gate capacitor provides better functionality at lower cost. Fewer and less expensive components such as IGBT's also may be used for further savings.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator drive assembly, comprising:
an electrical machine;
a drive that controls operation of the electrical machine to achieve a desired elevator system operation; and
a capacitive energy storing device comprising at least one double-layer electrochemical capacitor electrically coupled with at least the drive for selectively receiving electrical energy from operation of the electrical machine or providing electrical energy for use in operating the electrical machine.

2. The assembly of claim 1, wherein the capacitive energy storing device comprises at least one nano-gate capacitor.

3. The assembly of claim 1, wherein the drive controls energy supply from at least one capacitor for use in operating the electrical machine when the electrical machine is accelerating.

4. The assembly of claim 1, wherein the drive controls receipt of energy by the at least one capacitor during deceleration of the electrical machine.

5. The assembly of claim 1, wherein the electrical machine comprises at least one of an AC motor or a permanent magnet motor.

6. A method of operating an elevator drive assembly, comprising the steps of:
selectively and electrically coupling a capacitive energy storing device that includes at least one double-layer electrochemical capacitor with an electrical machine or a drive of the drive assembly;
providing electrical energy resulting from operation of the electrical machine to the capacitive energy storing device during a first operating condition of the motor; and
providing electrical energy from the capacitive energy storing device for operating the electrical machine during a second operating condition of the motor.

7. The method of claim 6, wherein the capacitive energy storing device comprises at least one nano-gate capacitor.

8. The method of claim 6, wherein the first operating condition of the electrical machine comprises electrical machine deceleration.

9. The method of claim 6, wherein the second operating condition of the electrical machine comprises electrical machine acceleration.

10. The method of claim 6, wherein the electrical machine comprises at least one of an AC motor or a permanent magnet motor.
